(19) United States
(12) Patent Application Publication
(10) Pub. No.: US 2010/0115695 A1
(43) Pub. Date: May 13, 2010

(54) Dampened Belt Retractor

(76) Inventors: Elizabeth A. White, American Fork, UT (US); Jacob H. Ely, Del City, OK (US)

Correspondence Address: Floris Chad Copier, 5373 W. 10480 N., Highland, UT, 84003, US

(21) Appl. No.: 12/567,797

(22) Filed: Sep. 27, 2009

Related U.S. Application Data
(63) Continuation-in-part of application No. 12/121,713, filed on May 15, 2008.
Application No. 12/121,713 is a continuation-in-part of application No. 11/403,112, filed on Apr. 12, 2006.
Application No. 11/403,112 is a continuation-in-part of application No. 11/788,962, filed on Apr. 23, 2007, now abandoned.

(51) Int. Cl. B65H 75/44; B65H 75/48; A61G 7/10

(52) U.S. Cl. 5/81.1 R; 242/381

(57) ABSTRACT

A patient positioning apparatus including at least one dampened belt retractor, a base, a support column, at least one positioning arm on the support column capable of being positioned over a bed and having a buckle and strap capable of securing to a patient support connected to bed linens or other flexible member so that a patient can be partially or totally suspended when an adjustable bed is lowered or when the patient support is raised.

### PRIORITY

This application is a continuation-in-part of U.S. patent application Ser. No. 12/121,713 filed May 15, 2008, which is a continuation-in-part of both U.S. patent application Ser. No. 11/403,112 filed Apr. 12, 2006, and U.S. patent application Ser. No. 11/788,962 filed Apr. 23, 2007. This application claims priority to each of the above-referenced applications, which are incorporated herein by reference in their entireties.

### FIELD

This application relates generally to locking belt retractors. More particularly, this application relates to a dampened belt retractor that may be used with patient repositioning units that facilitate movement or suspension of the individual on a flexible member by utilizing existing lift technology on a moveable bed or on the frame.

### BACKGROUND

Immobility of a patient contributes greatly to the deterioration of patient health. Immobile patients are prone to bedsores and pneumonia. A bed sore can take months or years to heal depending on the severity and location of the sore. Pneumonia occurs in immobile patients because secretions pool in the lungs fostering bacterial growth. Generally side-to-side turns of such patients, approximately every two hours, can prevent many occurrences of bedsores and pneumonia. Additionally, side-to-side turns are necessary to accomplish examinations of the patient. However, turns of this nature are generally the responsibility of hospital nurses, orderlies, or other staff in similar types of facilities.

Additionally, patients require the head of the bed to be raised to facilitate breathing and increase comfort. As a result of this incline, patients tend to slide toward the foot of the bed, impeding a patient's normal breathing and digestive functions and resulting in patient discomfort.

When a patient is obese or larger than the staff member, the force required to properly reposition the patient is considerable. Consequently, multiple staff members are required to reposition the patient manually. Moreover, if additional staff members are unavailable, the lone staff member is susceptible to injuries while attempting to transfer or reposition the patient without either mechanical assistance or, additional staff labor.

Back injury is a common work injury of nurses and hospital staff generally as a result of moving overweight, obese or patients who are significantly larger than the staff member. The act of turning a patient from side to side precludes proper body mechanics for lifting. In addition, obesity in the United States is increasing in marked amounts. Patient weight increases will only exacerbate the rate of back injuries among nurses, and increase the number of workers compensation claims filed as a result of such injuries as well as reduce the number of able body hospital staff. Consequently, assistance is necessarily required to accomplish necessary patient movement as well as protect hospital staff members against injury proximately resulting from patient repositioning, turning and transference.

Moreover, the task of patient repositioning is labor intensive and time consuming. Generally, patient movement requires at least two staff members. Generally nurses are female and significantly smaller in stature and weight then the patients they are assigned to care for. Furthermore, hospitals and skilled nursing facilities are homes to patients weighing in excess of 250 pounds. Consequently, at least three staff members are sometimes required to reposition a patient of this size. With the increase of nursing and staffing shortages, it is frequently impossible to gather enough staff members to move a large or oversized patient. Thus, either patient care suffers or the risk of injury to staff members is greatly increased.

Another problem is money. Devices that incorporate machines, motors, and other complicated machinations to effectuate lift and other movement cost much more money than those that don't as well as incur more potential for civil liability should one of those machinations fail. Further, existing devices do not have a simple and effective means of gripping fabric, draw sheets, or standard hospital bed linens on which a patient is lying. Typically, devices such as that found in U.S. Pat. No. 5,890,238 to Votel are meant for patient transfer only at least because the gripping design is not designed for a caregiver to attach to linens.

Therefore a need exists for a functional, yet simple to operate, patient repositioning apparatus. Such an apparatus must be operational by one staff member without compromising patient safety and staff member safety; easy to install and operate as well as not consume scarce space in hospital or skilled nursing facility; must not compromise patient safety when effectuating the tasks of patient repositioning; can be used by a single caregiver to reposition a patient; is capable of easy attachment to linens for suspension of a person; and does not require expensive internal machinations to accomplish patient lift but uses existing lift technology on beds to accomplish suspension or movement of a patient.

### SUMMARY

This application describes and discloses a dampened belt retractor for use with a patient positioning apparatus that includes a base, at least one support column, at least one positioning arm capable of being positioned over a bed and having a buckle and dampened strap capable of securing to a patient support connected to bed linens or other flexible member so that a patient can be partially or totally suspended when an adjustable bed is lowered or when the patient support is raised.

Patient repositioning may be effectuated by positioning the arms over a patient, extending straps out of an automatically locking belt retractor with buckle inserts into receiving buckles on a patient support or support bar secured to bed linens. The extending straps may automatically lock at a desired length and retract when weight is removed from the straps. The retraction mechanism may include a dampener to prevent the straps and buckle from retracting quickly and potentially causing damage to the patient positioning apparatus or injury to a person close to the straps. A patient positioning apparatus may be free-standing or may be mounted to a ceiling or a wall or may include a swiveling support column. A fabric gripper may be used to connect the flexible member to the apparatus.

These and other aspects of the present invention will become more fully apparent from the following description and appended claims.

### BRIEF DESCRIPTION OF THE DRAWINGS

The following description can be better understood in light of Figures, in which:

FIG. 1 is an elevated perspective view of an exemplary embodiment of a patient positioning apparatus with arms in an extended position;

FIG. 2 is an elevated perspective view of an exemplary embodiment of a patient positioning apparatus with arms in a retracted position;

FIG. 3 is an elevated perspective view of an exemplary embodiment of a patient positioning apparatus positioned over a moveable bed and attached to a flexible member;

FIG. 4 is an elevated perspective view of an exemplary embodiment of a patient positioning apparatus positioned over a moveable bed and attached to a flexible member with an individual reposing on the flexible member;

FIG. 5 is a side view of an exemplary embodiment of a patient positioning apparatus positioned over a moveable bed and attached to a flexible member with an individual reposing on the flexible member;

FIGS. 6-9 illustrate an exemplary embodiment of a flexible member gripper; and

FIG. 10 illustrates an exemplary embodiment of a dampened strap retractor; and

Together with the following description, the Figures demonstrate and explain the principles of a dampened strap retractor for use with patient positioning systems and associated components and methods. In the Figures, the thickness and configuration of components may be exaggerated for clarity. The same reference numerals in different Figures represent the same component.

### DETAILED DESCRIPTION

In the illustrated embodiments, aspects and features of patient repositioning systems and associated components and methods are disclosed and described below.

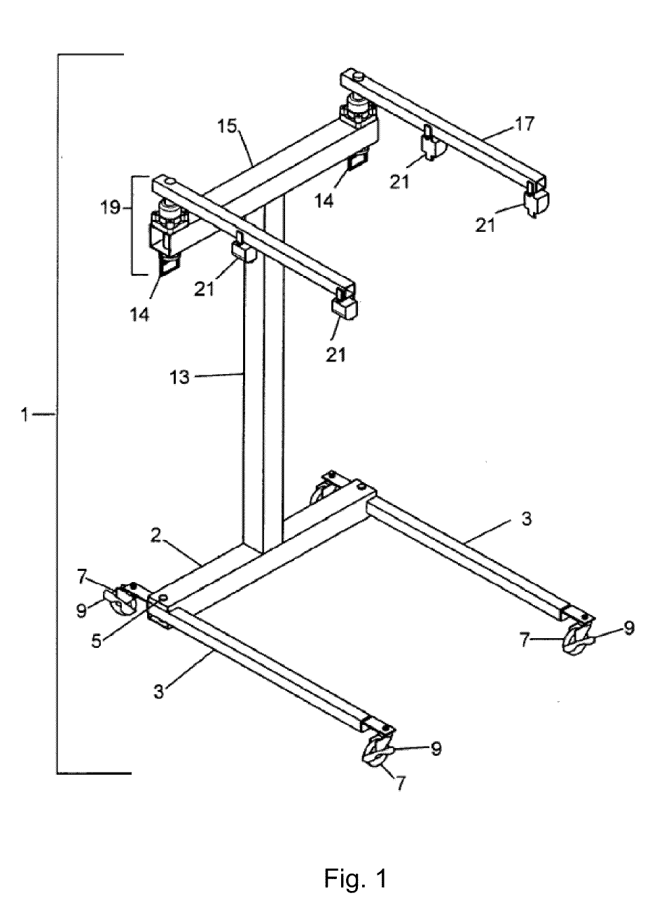

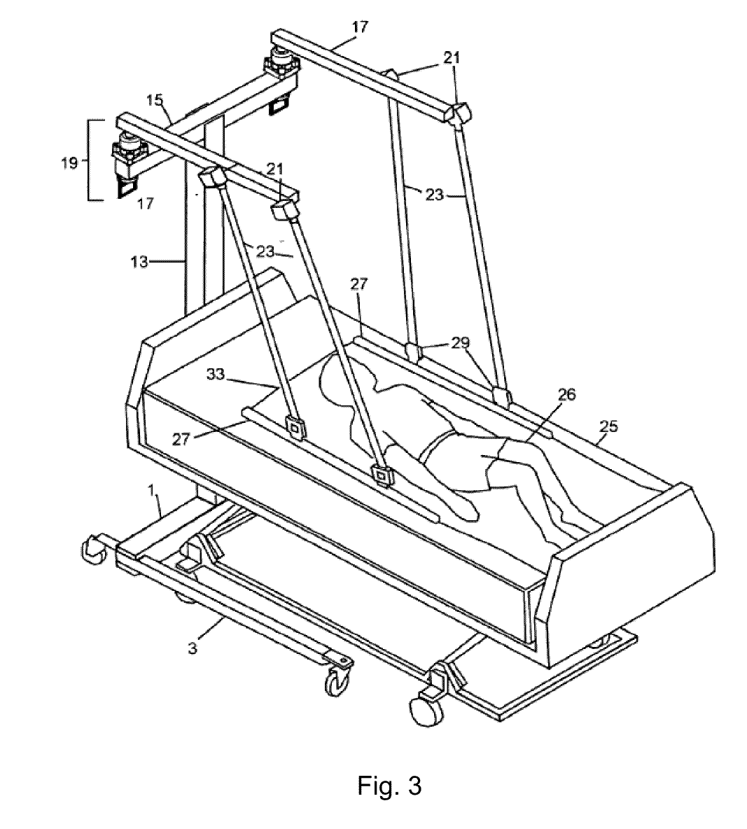

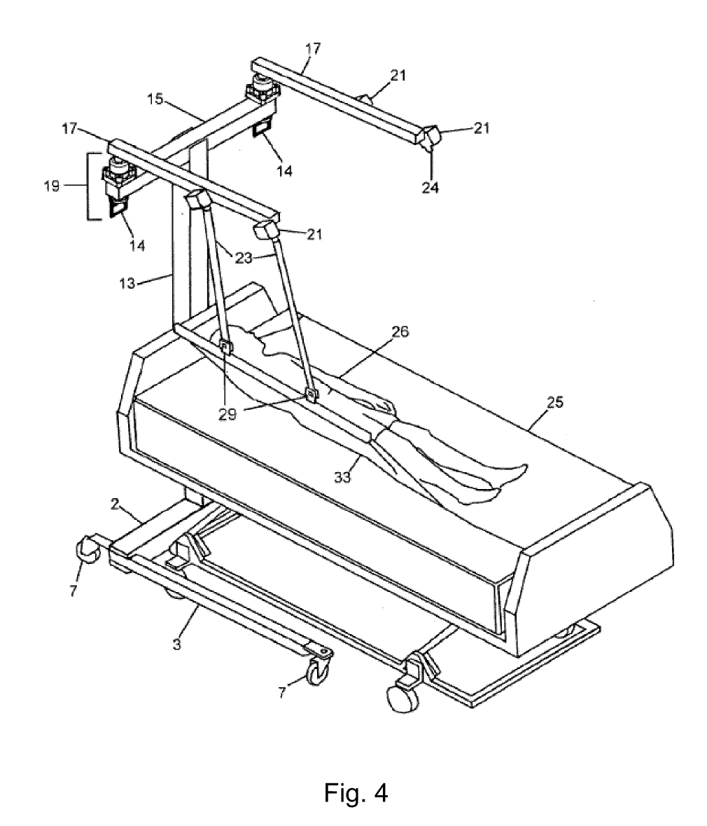

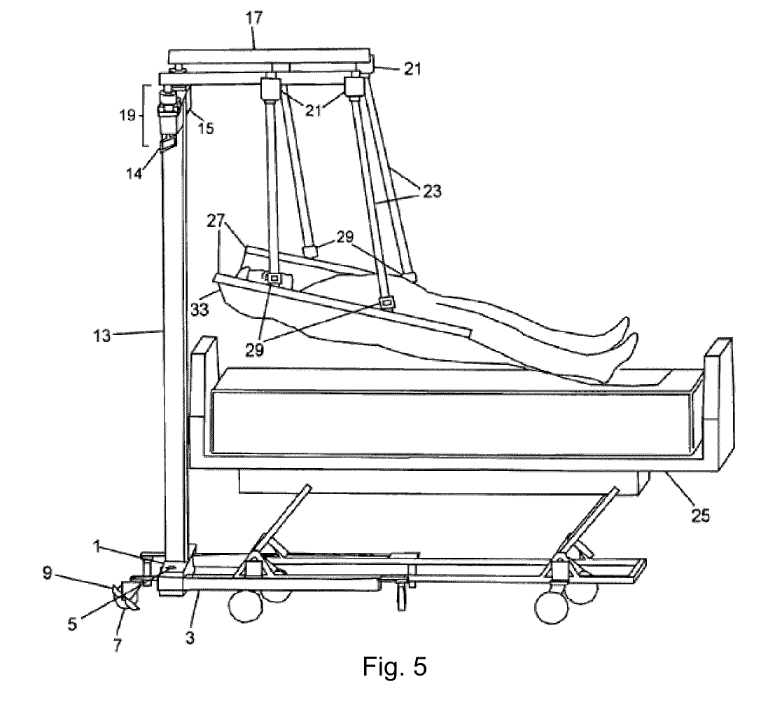

FIG. 1 is illustrative of an embodiment for repositioning an individual, such as a patient, reposing in a standard hospital bed. As used in this application, suspended or suspend may also include partially suspended or partially suspend where the bed or some other member also assists in supporting the patient. In some embodiments, positioning system 1 may include moveable base with wheels 7, vertical support column 13, and one or more positioning arms 17 on the top of system 1 containing straps 23 extending from dampened belt retractors 21 that extend downward and secure to flexible member 33 (FIGS. 3-4). As used throughout this disclosure, flexible member 33 may be a bed sheet, bed linen, sling, plastic sheet, blanket, quilt, quilted bat, or any other material that may be used to support an individual.

As shown in FIGS. 3 and 4, a patient on support surface 25, such as a bed, hospital bed, cot, stretcher, or other surface on which an individual may repose, may be repositioned using system 1. In some embodiments system 1 may be used to reposition a patient by using the vertical movement of a standard hospital bed. (e.g., electrical, crank actuated, other mechanical motion, etc.) Bed 25 may be raised upward towards positioning arms 17, until gripping straps 23 with retractable belt assembly 21 on arms 17 are in position to be attached. Once there is enough length of straps 23, buckle 24 on the ends of straps 23 may be inserted and locked into buckle latch 29 coupled to flexible member 33. Once buckles 24 are locked, bed 25 may be lowered, separating flexible member 33 from bed 25, causing the patient or a portion of the patient to be suspended above bed 25.

One embodiment of a base portion includes one or more legs 3 capable of extending in opposite directions from either the anterior or posterior of support column 13.

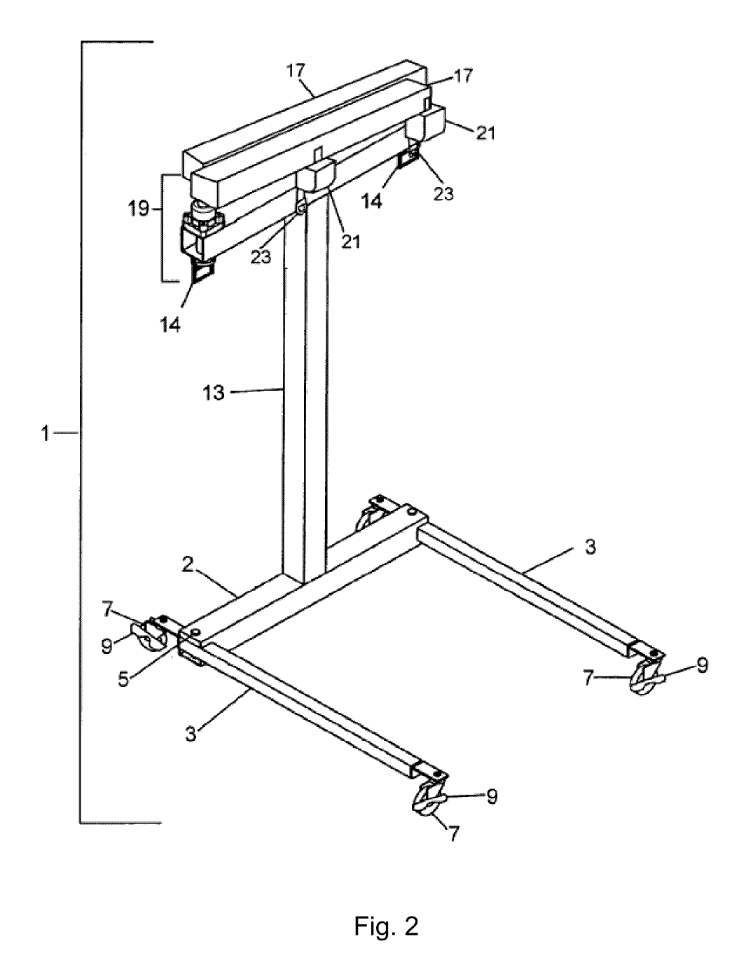

FIGS. 1 and 2 also show support column 13 coupled to base 2. Column 13 and base 2 may be coupled by welding, pins, bolts, etc. In some embodiments, support column 13 may be fixed and capable of supporting a repositioning structure including horizontal support 15 and one or more positioning arms 17. The repositioning structure may be fixedly or removably coupled to support column 13 such as the top of support column 13 as shown in FIGS. 1 and 2. The repositioning structure may also be fixed to any place on the support column 13 so long as it is capable of being positioned over an individual on a support surface for repositioning.

Support column 13 may be constructed of powder-coated steel and may be 4 inches square, so as to withstand the weight of an individual 26 of any known weight, and suspended by arms 17. Dampened belt retractors 21 may be coupled to positioning arms 17 using support tabs 16 (See, FIG. 9) whereby a rivet (not shown) may be inserted through tab 16 and through positioning arm 17. Other similar methods will be immediately recognizable for securing similar assemblies to metal structures such as those disclosed. For example, support column 13 may be more than one support column attached to base 2. In such arrangements, the more than one support columns may have a smaller dimension than a single column since multiple columns would support the load rather than a single column.

Similarly, support column 13 may include additional nested columns. An outer column of the support column may swivel around an inner column with apertures. The outer column support, also having apertures, may be capable of aligning with those of the inner column by inserting the outer column over the inner column. In this way the swivel can be locked by inserting a locking pin through each of the inner and outer column support apertures. Other known manners of creating a swiveling column will be immediately recognized by those skilled in the art.

Most hospital beds are of a standard height. Because of the uniform height of hospital beds, a fixed height support column 13 may be effective in providing sufficient height to system 1. However, because some beds may vary in height and in the levels of vertical movement, some embodiments may also accommodate vertical movement of support column 13, or of the overall height of system 1.

To effectuate vertical movement of system 1, a crank assembly or a hydraulic assembly as described in related U.S. patent application Ser. No. 11/170,605 “Patient Mobility Apparatus” to White disclosed above may be incorporated into the present invention.

The repositioning structure coupled to support column 13 may be used for repositioning a patient 26 in bed 25. The position of the repositioning structure and associated structures such as arms 17 relative to bed 25 and the motor of bed 25 may be used together to repositioning a patient 26. For example, standard hospital beds typically come with an electric motor or other adjustable beds used to raise, lower, or otherwise place bed 25 in various positions. Taking advantage of this standard lifting and repositioning feature along with system 1 may allow for a single caregiver to easily reposition patient 26.

FIGS. 3 and 4 illustrate repositioning movement using an illustrated embodiment. In FIG. 3, person 26 is laid flat on flexible member 33 that has pockets 27 capable of receiving support bar 47, making portions of flexible member 33 adjacent to pockets 27 rigid. Support bar 47 may also have receiving buckles 29 for receiving straps 23 with buckle inserts 24. A caregiver may position bed 25 to an appropriate distance below arms 17 such that straps 23 are slack and buckle inserts 24 can be inserted into receiving buckles 29. Once buckle inserts 24 are inserted into the receiving buckles 29, a caregiver may then either allow tension in the straps 23 through adjustment of the straps 23 through automatic adjustment using automatic retraction in the dampened belt retractors 21, or through manual adjustments methods. Any remaining slack may be taken out by lowering bed 25 until patient 26, or a portion of patient 26 is suspended on flexible member 33 and above bed 25. Once patient 26 is suspended, a caregiver may change bed linens, place pillows under portions of patient 26, or perform other various tasks related to caring for a patient

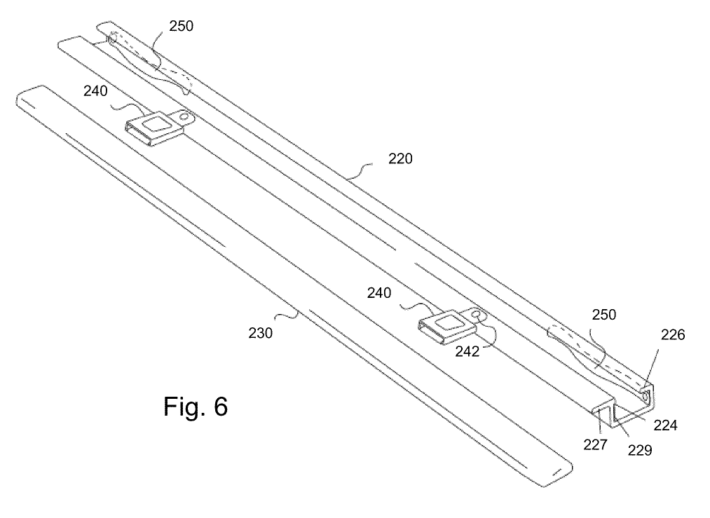

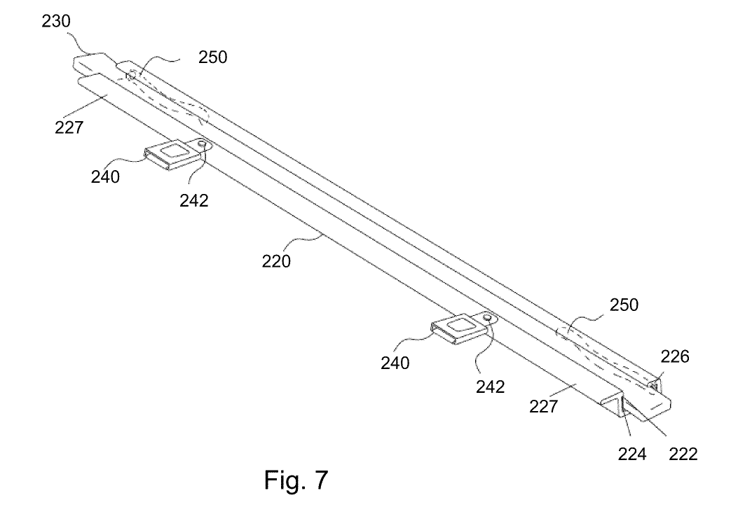

In some embodiments, such as those illustrated in FIGS. 6-9, support bar 47 may be attached to flexible member 33 to provide receiving buckles 29 for insertion to effectuate repositioning of patient 26.

For example, FIG. 4 demonstrates one embodiment being used to turn a patient a quarter turn by inserting only buckle inserts 24 into receiving buckles 29 of support bar 47 on one side of flexible member 33. In this way, once bed 25 is lowered, patient 26 may be partially suspended as flexible member 33 lifts under one side of patient 26, causing patient 26 to roll to one side. Once patient 26 is partially rolled to one side, a nurse or other caregiver may place pillows or other supports under the lifted side of patient 26 such that when bed 25 is raised, patient 26 can rest on the pillows or other supports to maintain a turned position. Thereafter, system 1 may be removed from flexible member 33, or may be otherwise disconnected until needed again. In other embodiments, system 1 may be used to move patient 26 from lying on their back to their front, or vice versa.

To change patients' bed linens, flexible member 33 may be placed underneath patient 26 and bed linens, or flexible member 33 may be the bottom-most layer of bed linens. Bed 25 may then be raised enough to allow for the insertion of the buckle inserts 24 into receiving buckles 29 on one side of flexible member 33. The dirty bed linens may then be loosened from one side of bed 25. By then lowering bed 25, patient 26 may roll to one side of bed 25, allowing removal of a portion of the dirty bed linens, and partial replacement with clean bed linens. Bed 25 may then be raised and buckle inserts 24 removed from receiving buckles 29 and flexible member 33 may be spread back onto the bed mattress. Once the dirty bed linens are rolled off of the mattress and next to patient 26, exposing a bare portion of the mattress on bed 25, the clean linens may be spread on the bare side of the mattress with the remaining clean linens rolled up next to the patient 26. Then, on the other side of bed, flexible member 33 may be similarly raised allowing the dirty linens to be removed from bed 25 and allowing the clean linens to cover the entire mattress. Bed 25 may then be lowered whereby patient 26 rolls onto the clean linen and over the remaining clean linen portion rolled next to patient 26. The bed may then be raised and buckle inserts 24 removed from flexible member 33. Therefore, the dirty linen may be finally removed and the clean linen can be pulled out from underneath the patient 26 and spread uniformly over the mattress.

In their simplest form, arms 17 may remain fixed and extend outward from support column 13, thereby allowing them to be positioned over patient 26 in bed 25. In one embodiment, as shown in FIG. 1 and in an exploded view in FIG. 9, arms 17 may be joined to horizontal support 15 through locking arm pivots 19 that allow arms 17 to extend outward when in use and to retract inward toward support column 13 when not in use. The pivot pin arrangement may incorporates pivot shafts 4 placed inside flange bearing 6 and bearing extension plate 8, allowing shaft 4 to rotate. Shaft 4, bearing 6, and extension plate 8 may then be situated over an aperture on both the top and bottom of arm 17. On the bottom of arm 17 may be a hole stiffener 10 and sleeve 11 into which shaft 4 can be inserted and over, which may be inserted top washer 12 and bottom washer 22, and spring loaded handle 14 capable of engaging and disengaging washers 12, 22, thereby allowing arms 17 to rotate. When handle 14 is released, washers 12, 22 may engage to lock arm 17 in place. Alternatively, a simple pivot mechanism may also provide the desired function. The advantage of a washer assembly is that it may allow both of arms 17 to retract and extend at an equal height. Other embodiments of exemplary assemblies may also provide movement acceptable for purposes of achieving the objects of the embodiments disclosed herein.

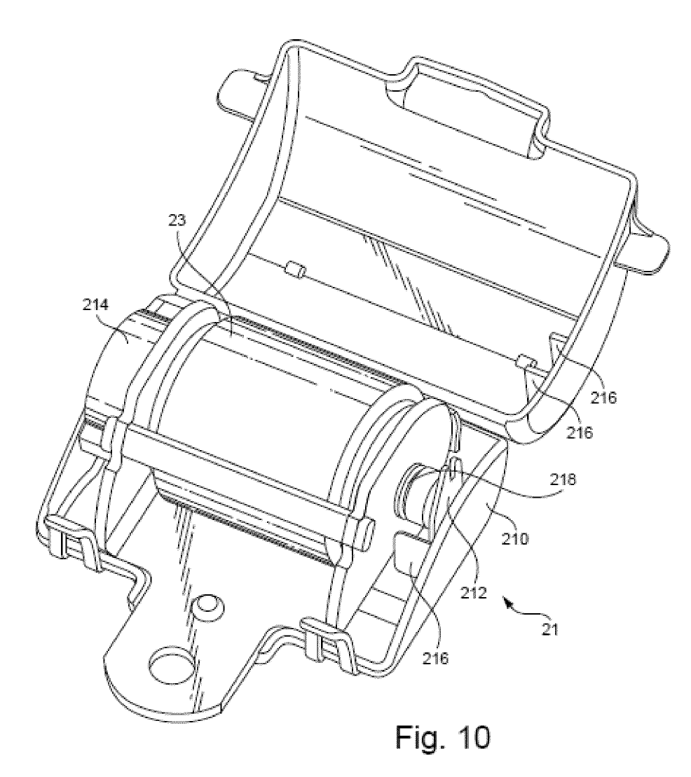

Once arm 17 is positioned over a patient 26, it may be secured to flexible member 33 through the use of a buckle assembly as describe above, and capable of supporting patient 26, and may be sufficiently strong to support any size and weight of patient 26. Because patients may be large and/or overweight, retractable straps with buckles using heavy duty nylon, polyester, canvas or other similar materials can be used to provide sufficient strength to support a patient of any weight. As shown in FIG. 10, re Further, the receiving mechanism for the buckles can be attached to the support sheet, a gripper or other mechanism secured to the support sheet or in other embodiments those skilled in the art will immediately appreciate.

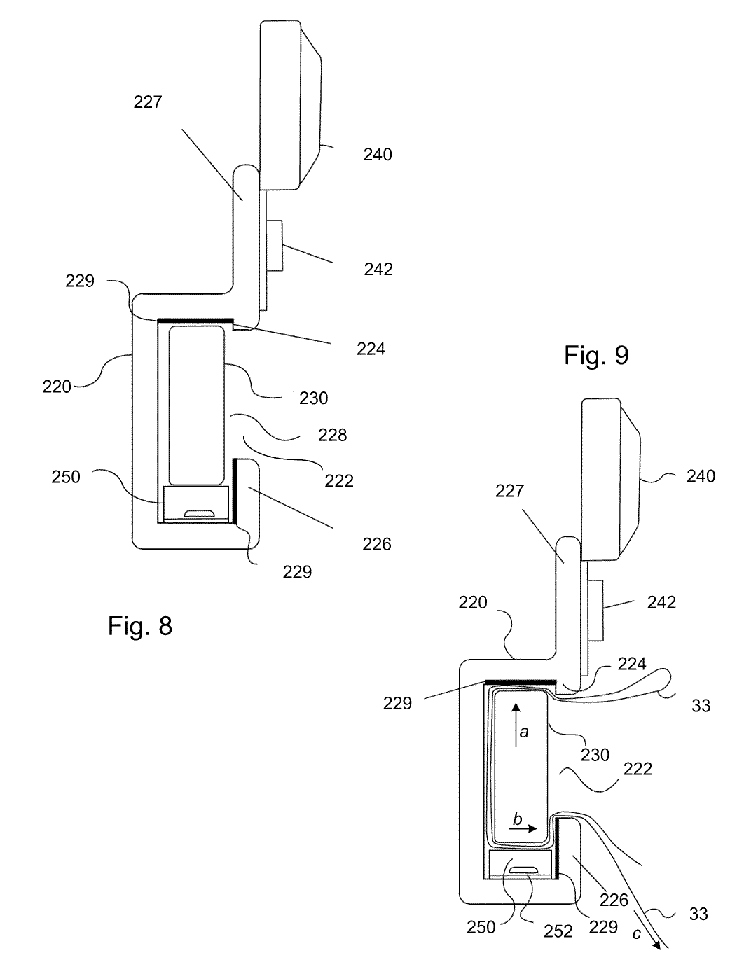

Some embodiments for securing support arms 17 to flexible member 33 may be to use a sling-type arrangement as shown in FIGS. 8-8a. In such embodiments, support hooks 45 with hook gates 47, such as with a carabiner, may be used to support flexible member 33 by holding support bar 47, placed in pocket 27, and then attaching to support arms 17.

In some embodiments, straps 23 of any durable material can be fixed, permanent or removable, to either dampened belt retractors 21, belt 23 or the receiving buckles 29 that incorporate a traditional belt and buckle arrangement. Using this arrangement, straps 23 can be extended to a desired length, much as retractable seatbelts in cars may be secured at a particular length. When not in use they can then be placed to the side of the bed. As shown in FIG. 10, dampened belt retractors 21 may include case 210, rotational dampener 212 attached to center pin 218, about which strap 23 is wound, and spring 214 also attached to center pin 218 that provides the retracting force to strap 23. A locking mechanism may also be included to provide locking at a particular length of strap 23.

Case 210 also includes holds 216 which may be integrally molded into case 210 to hold an exterior portion of rotational dampener 212 in a fixed relationship with case 210 such that it provides dampening to center pin 218 when the interior portion of rotational dampener 212 rotates along center pin 218 in response to spring 214 retracting belt 23, causing a resistive force to the retraction based on the angular velocity of the spool holding retracting belt 23 thereby decreasing the belt retraction velocity. Thus, the higher the rotational velocity of center pin 218, the more resistive force is applied by rotational dampener 212.

Flexible members 33 may provide a stable, flexible, lifting platform on which to lift patients. Some exemplary flexible members 33 may be made of vinyl, nylon, canvas, bed sheets, draw sheets, mattress pads, or other materials or configuration sufficient to accomplish lifting a patient or a portion of a patient reposing on flexible member 33, as desired. In other embodiments, harnesses, slings, stretchers or other known suspension supports may also be used in and with the embodiments disclosed herein. Flexible members 33 may also incorporate buckles fastened to them using known techniques such as sewing heavy duty buckle ends to reinforced material and stitching onto the body of flexible member 33.

In some embodiments, a detachable fabric gripper may be used as is shown in FIGS. 6-9, which may be attached to linens found in hospitals and other patient care facilities. Fabric clamp 200 may include support bar 220, insert bar 230, and attachment members 240. Support bar 230 may have a general cross-section that provides an internal space 228 for holding and for insertion of insert bar 230. Some exemplary cross-sections may be diamond, oblong, polygonal, or any other configuration that would allow functional use with an insert bar as described herein. For example, as shown in FIG. 18, support bar 220 may have a generally rectangular cross-section with one side of the rectangle having an opening 222 to allow insertion of insert bar 230. Flanges 224 and 226 may define opening 222, and may function to engage portions of insert bar 230 when placed into support bar 220 to maintain insert bar 230 within support bar 220, or otherwise provide structure to reduce the ability of insert bar 230 to fall out of support bar 220. While flanges 224 and 226 are opposing in the illustrated Figures, flanges 224 and 226, or other similar features of some embodiments, may be offset or with varying angles.

Support bar 220 may have a length sufficient to support an individual or a desired portion of an individual. For example, support bar 220 may be between about two and about seven feet long. In some embodiments, support bar 220 may be shorter to only support an upper or lower portion of an individual as needed. For example, system 1 may be used to suspend the legs of an individual, such that a shorter support bar 220 may be preferable to a longer support bar 220. Similarly, any of the devices described herein for attaching to flexible member 33 may be similarly arranged in length.

In some embodiments, resilient member 250 may be located in support bar 220. As shown in FIG. 9, resilient member 250 may bias insert bar 230 towards a top of insert bar 230 and towards attachment members 240, and against an interior surface of insert bar 230. Resilient member 250 may be one or more leaf springs attached to a bottom interior surface of support bar 220, or may be one or more coil springs, or any other type of resilient member sufficient to bias insert bar 230 into contact with support bar 220.

In some embodiments, resilient member 250 may be attached to insert bar 230, or may be integral with insert bar 230. For example, as shown in FIGS. 8-9, fastener 252 may couple resilient member 250 to support bar 220. Resilient member 250 may also provide sufficient force to trap flexible member 33 between insert bar 230 and support bar 220, as shown in FIG. 19. In some embodiments, resilient member 250 may also provide a tactile assurance that insert bar 230 is properly seated in support bar 220 by providing a “click” as insert bar moves past flange 224 and is moved by resilient member into position in support bar 220.

Insert bar 230 may be shaped such that it approximates the cross-sectional shape of internal space 228 of support bar 220 such that flexible member 33 is contacted and compressed between insert bar and support bar 220 at various points to prevent slippage or removal of flexible member 33 as a load is applied to flexible member 33, as described above with using system 1.

In some embodiments, fabric clamp 220 may provide structure such that when a load (as represented by arrow c in FIG. 19) is applied to flexible member 33, the load is borne initially by support bar 220. For example, as shown in FIG. 19, a load applied to flexible member 33 may be borne by flange 226 of support bar 220. As further shown in FIG. 19, when a load is applied to flexible member 33, insert bar 230 is pressed upwardly, as indicated by the arrows a, and against flange 226, as indicated by arrow b, compressing flexible member 33 between at least contact areas 229 between insert bar 230 and support bar 220. As the load of flexible member 33 increases, the compression force between insert bar 230 and support bar 220 increases such that flexible member 33 may be prevented from slipping with respect to or separating from fabric gripper 210.

In some embodiments, contact areas 229 may include a coating, surface finish, applied material, or other technique to provide a slip-resistant surface. For example, contact areas 229 may be coated with rubber, foam tape, or other applied material, or may have a rough surface from machining, rough sanding, or other manufacturing process. In some embodiments, the slip-resistant surface features may be applied to contact areas 229 of support bar 220, to corresponding regions of insert bar 230, to both support bar 220 and insert bar 230, or to any and all surfaces of support bar 220 and insert bar 230 that may contact flexible member 33.

Attachment members 240 may be coupled to support bar 220. In some embodiments, attachment members 240 may be pivotably coupled to upper flange 227 of support bar 220 using fasteners 242, such as rivets, bolts, wave washers, springs, or using any known techniques, or may be fixed to support bar 220 by welding, fasteners, etc., or may be integral with support bar 220. Attachment members 240 may be buckles, such as seat belt buckles, as shown in FIGS. 6-9, or may be a ring or carabiner-type attachment. In some embodiments, attachment members 240 may be any configuration that allows attachment to a support member, such as support arms 17 of system 1, for example, a simple loop, a hole in support bar 220, a bracket, or any other devices or means to connect support fabric gripper 210 to system 1. Each fabric gripper 210 may include one or more attachment members, depending on the desired length and application.

In some embodiments, flexible member 33 may be placed in fabric gripper 210 by laying a portion of flexible member 33 over opening 222, placing insert bar 230 into internal space 228 of support bar 220 such that resilient member 250 compresses, thereby trapping a portion of flexible member 33 between insert bar 230 and support bar 220. Flexible member 33 may be removed from fabric gripper 210 by pulling a portion of flexible member 33 extending past flange 224 downward such that resilient member 250 is compressed and the top portion of insert bar 230 moves past flange 226, allowing insert bar 230 to rotate out through opening 222, freeing flexible member 33.

While the above description contains various preferred, exemplary, and other specific embodiments, these should not be construed as limitations on the scope, but as exemplifications of the presently preferred embodiments thereof. Many other embodiments and variations are possible within the teaching of this document. Thus, the scope of the invention should be determined by the appended claims and their legal equivalents, and not solely by the examples and embodiments given.

What is claimed is:

1. A device, comprising:
a housing;
a belt coupled to the housing such that when retracted, the belt is wound up;
a spring configured to provide biasing for the belt in a refracted position;
a dampener coupled to the belt such that the dampener slows the motion of the belt when being refracted.

2. The device of claim 1, wherein the dampener is a rotational dampener.

3. The device of claim 1, wherein a first portion of the dampener is held in a fixed position relative to the housing, and wherein a second portion of the dampener rotates when the belt is being retracted.

4. The device of claim 1, wherein the housing is coupled to a patient position device.

5. The device of claim 4, wherein the belt is configured to be releasably affixed to a fabric gripper.

6. The device of claim 4, wherein the patient positioning device is configured to at least partially suspend a patient above a bed, the patient being at least partially supported by the belt.

7. The device of claim 4, wherein the device is one of a plurality of similar devices coupled to the patient position device.

8. An apparatus, comprising:
a frame;
at least one support arm coupled to the frame;
at least one dampened belt retractor coupled to the at least one support arm, the at least one dampened belt retractor including a belt; and
a fabric gripper releasably coupled to the belt, wherein the fabric gripper is configured such that when the fabric gripper is attached to a bedsheet located on a patient bed and the patient bed is lowered away from the bedsheet, the patient is at least partially suspended and supported by the belt.

9. The device of claim 8, wherein at least one dampened belt retractor includes a rotational dampener.

10. The device of claim 9, wherein the rotational dampener is configured to provide resistance to the action of the belt retracting into the dampened belt retractor.

11. The device of claim 10, wherein the belt is releasably coupled to the fabric gripper with a buckle and latch assembly.

12. The device of claim 8, wherein the at least one support arm extends above the patient bed.

13. The device of claim 8, wherein the apparatus includes no electric motor for raising or lowering any portion of the device.

14. The device of claim 8, wherein the dampened belt retractor includes a locking mechanism allowing the belt to be held at a desired extended length from the at least one support arm.

15. The device of claim 8, further comprising a base coupled to the frame, wherein the base extends below the at least one support arm.

16. The device of claim 15, wherein the base includes locking wheels.
